(19) United States
(12) Patent Application Publication
(10) Pub. No.: US 2016/0191624 A1
(43) Pub. Date: Jun. 30, 2016

(54) HYBRID BRIDGE FOR PROVIDING A BROWSERLESS FILE STORAGE AND SYNCHRONIZATION SERVICE

(71) Applicant: Mark Hufstetler, Salt Lake CIty, UT (US)

(72) Inventor: Mark Hufstetler, Salt Lake CIty, UT (US)

(21) Appl. No.: 14/968,742

(22) Filed: Dec. 14, 2015

Related U.S. Application Data
(60) Provisional application No. 62/091,304, filed on Dec. 12, 2014.

(51) Int. Cl. H04L 29/08

(52) U.S. Cl. CPC H04L 67/1097; H04L 67/1095

(57) ABSTRACT

The disclosure includes a system and method for providing a browserless file storage and synchronization service for a client using a browserless device communicatively coupled to the client. The method may include determining a type for an operating system of the client. The method may include establishing one or more hooks with the operating system that are consistent with the type for the operating system. The method may include monitoring activity of the client using the one or more hooks. The method may include determining that an application included in the client is requesting to open a file stored on a server. The method may include providing application data to the client that is configured for the application to display content of the file which is stored on the server.

### CROSS-REFERENCE TO RELATED APPLICATIONS

This application claims the benefit of U.S. Provisional Application No. 62/091,304, filed Dec. 12, 2014, which is hereby incorporated by reference herein in its entirety, including but not limited to those portions that specifically appear hereinafter, the incorporation by reference being made with the following exception: In the event that any portion of the above-referenced provisional application is inconsistent with this application, this application supersedes said above-referenced provisional application.

### BACKGROUND

The specification relates to a hybrid bridge for providing a browserless file storage and synchronization service.

File storage and synchronization services are becoming increasingly popular. These services provide users with cloud storage, file sharing and collaborative editing.

Different file storage and synchronization services may provide different levels of privacy and security. Privacy may include the degree to which the stored files are secret from other users, the administrators of the service and parsing algorithms that may be included in the file storage and synchronization service. Security may include the degree to which the stored files may be accessed by unauthorized people, computers or algorithms. Security may also include the degree to which network communications between a client and a server that provides the file storage and synchronization service may be intercepted or monitored by unauthorized people, computers or algorithms.

### SUMMARY

According to one innovative aspect of the subject matter described in this disclosure, a method for providing a browserless file storage and synchronization service for a client using a browserless device communicatively coupled to the client. One or more steps of the method may be executed by a processor programmed to execute that step. The method may include determining a type for an operating system of the client. The method may include establishing one or more hooks with the operating system that are consistent with the type for the operating system. The method may include monitoring activity of the client using the one or more hooks. The method may include determining that an application included in the client is requesting to open a file stored on a server. The method may include providing application data to the client that is configured for the application to display content of the file which is stored on the server.

Other aspects include a processor and non-transitory memory storing instructions for performing one or more of these methods when executed by the processor.

An operating environment for implementing features of this disclosure may include a server. The server may provide the browserless file storage and synchronization service. The server may store one or more files associated with a user of a client. The server may be communicatively coupled to a network. A hybrid bridge may be communicatively coupled to the network and the client. The hybrid bridge may be a browserless device that interacts with the server through the network to provide the browserless file storage and synchronization service to the client. For example, the user of the client may open an application stored on the client. The hybrid bridge may monitor activity of the application using one or more hooks established with the operating system of the client. The user may provide inputs to request that the application open a file stored on the server. The hybrid bridge may detect the request to open the file using the one or more hooks. The hybrid bridge may interact with the server and the client to enable the application to display the content of the file even though the file remains stored on the server, and is not stored on the hybrid bridge of the client. As explained in more detail below, the user may view and edit the content of the file even though the file remains stored on the server and may never be stored on the hybrid bridge or the client.

Throughout the disclosure, the term “data” may be used to represent any digital data undergoing the transfer functions or operations described herein. The digital data may include, but is not limited to data to be shared between two or more entities (e.g., servers, firewalls, routers, hybrid bridges, clients, etc.) and data to be transferred between two or more entities. In some implementations the digital data may be stored on a non-transitory memory and accessed by a processor.

The digital data may include file data describing a file stored on the server. The file may have any extension type. A non-exclusive list of example extension types includes the following: .zip; .pdf; .doc; .xls; .ppt; .mp3; .aac; .wmv; .wma; .jpg; .rar; and .exe. The file data may be stored on the server and never provided to the hybrid bridge or the client.

The disclosure is particularly advantageous in a number of respects. Existing file storage and synchronization services have numerous deficiencies that are overcome by this disclosure. One deficiency of existing file storage and synchronization services is that they degrade the performance of the clients that use their services. Assume, for example, that a first user wants to share a file with a second user using an existing file storage and synchronization service. The file size is one terabyte in size. Existing file storage and synchronization services require the second user's client to synchronize with the server that stores the file. Because of the large file size, the second user's client will likely take as long as two hours to synchronize the file. During this synchronization process, the second user's client will perform other tasks at a slower speed because the resources of their client are being utilized to synchronize the shared file. By contrast, this disclosure describes a hybrid bridge that may be separate from the client. The hybrid bridge may manage communications with the server so that the resources of the client are not needed to enable access to files stored on the server. In this way, the hybrid bridge may provide the client with a browserless file storage and synchronization service in such a way that the performance of the client is not degraded by the synchronization functionality of the service.

A second deficiency of existing file storage and synchronization services is that they allow a user to access their files using a browser installed on a client associated with the user. All browsers have numerous security loopholes that may be utilized by malicious people, computers or algorithms to access the user's files or communications. By comparison, this disclosure describes a hybrid bridge that does not require a user to access their files using a browser. In some implementations, the hybrid bridge is configured so that it does not allow clients to access files using a browser. In this way, the hybrid bridge may provide the client with a browserless file storage and synchronization service that has increased security relative to existing solutions.

A third deficiency of existing file storage and synchronization services is that they allow a user to access their files using a special-purpose desktop application that is installed on a client associated with the user. These special-purpose desktop applications may include application programming interfaces (“API” or “APIs”) needed for the client to communicate with the server that provides the file storage and synchronization service. In this way, these special-purpose desktop applications are associated with the file storage and synchronization service to enable the user of the client to access their files which are stored on the server. However, these special-purpose desktop applications have many of the same security loopholes as browsers. By comparison, this disclosure describes a hybrid bridge that does not require a user to access their files using a special-purpose desktop application. In some implementations, the hybrid bridge is configured so that it does not allow clients to access files using a special-purpose desktop application. Instead, the hybrid bridge itself may include all the APIs necessary to communicate with the server so that these APIs do not need to be stored on the client. Instead of using a special-purpose desktop application to access a file, the hybrid bridge may establish one or more hooks with the operating system of the client. The hybrid bridge may use the hooks to monitor the activity of the client. The hybrid bridge may detect that the user is attempting to open a file using a browserless application of the client (i.e., a “file open event”). The browserless application may be any application of the client that does not include a browser or functionality tied to a browser. The hybrid bridge may intercept the communications associated with the file open event before the browserless application is aware of the file open event as a result of the hooking established between the hybrid bridge and the operating system of the client. The hybrid bridge may take actions to provide the browserless application with application data for enabling the user to view and edit the content of the file associated with the file open event. In this way, the hybrid bridge may provide the client with a browserless file storage and synchronization service that has increased security relative to existing solutions.

The advantages of the system described herein are provided by way of example, and the system may have numerous other advantages.

### BRIEF DESCRIPTION OF THE DRAWINGS

The disclosure is illustrated by way of example, and not by way of limitation in the figures of the accompanying drawings in which like reference numerals are used to refer to similar elements.

FIG. 1A is a block diagram illustrating an example system for providing browserless file storage and synchronization.

FIG. 1B is a block diagram illustrating an example system for providing browserless file storage and synchronization.

FIG. 2 is a block diagram illustrating an example hybrid bridge system.

FIG. 3 is a flowchart of an example method for configuring a hybrid bridge.

FIGS. 4A and 4B are a flowchart of an example method for a hybrid bridge to provide a browserless file storage and synchronization for a client.

FIG. 5 is a flowchart of an example method for server interaction with a hybrid bridge.

FIGS. 6A, 6B, 6C and 6D are graphical illustrations of example graphical user interfaces for a client to display content associated with a hybrid bridge.

### DETAILED DESCRIPTION

### System Overview

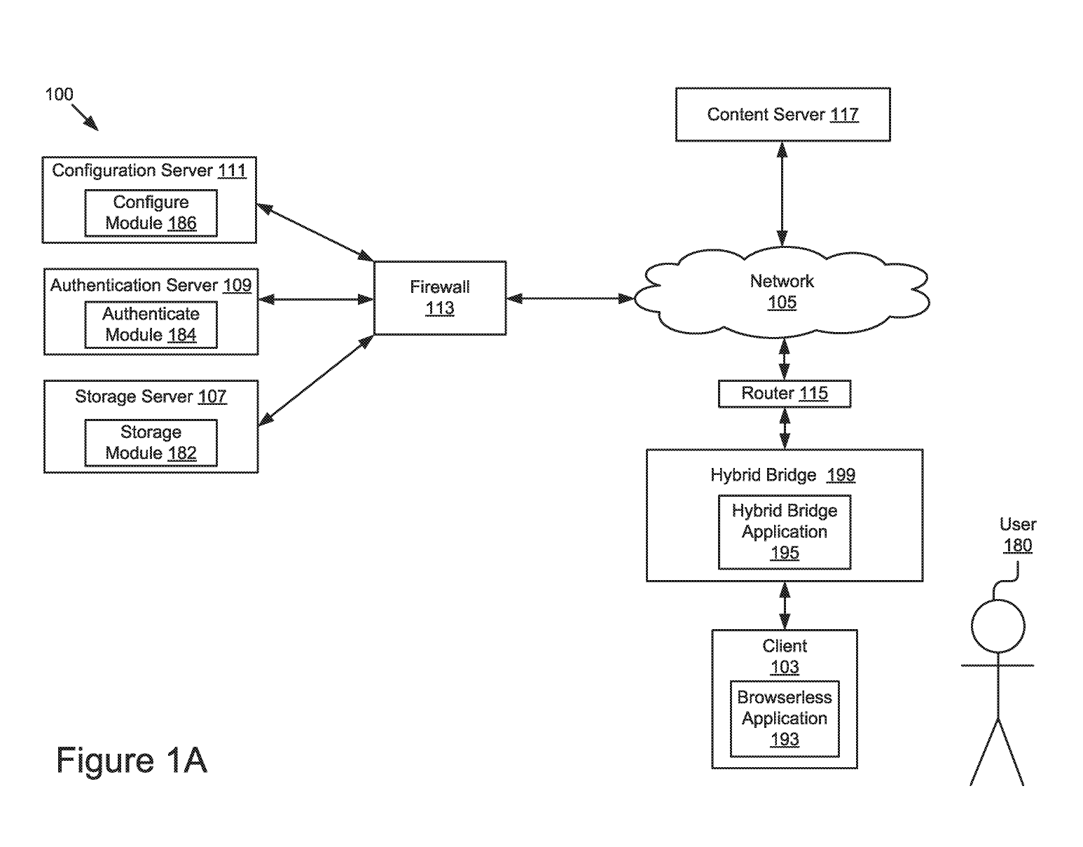

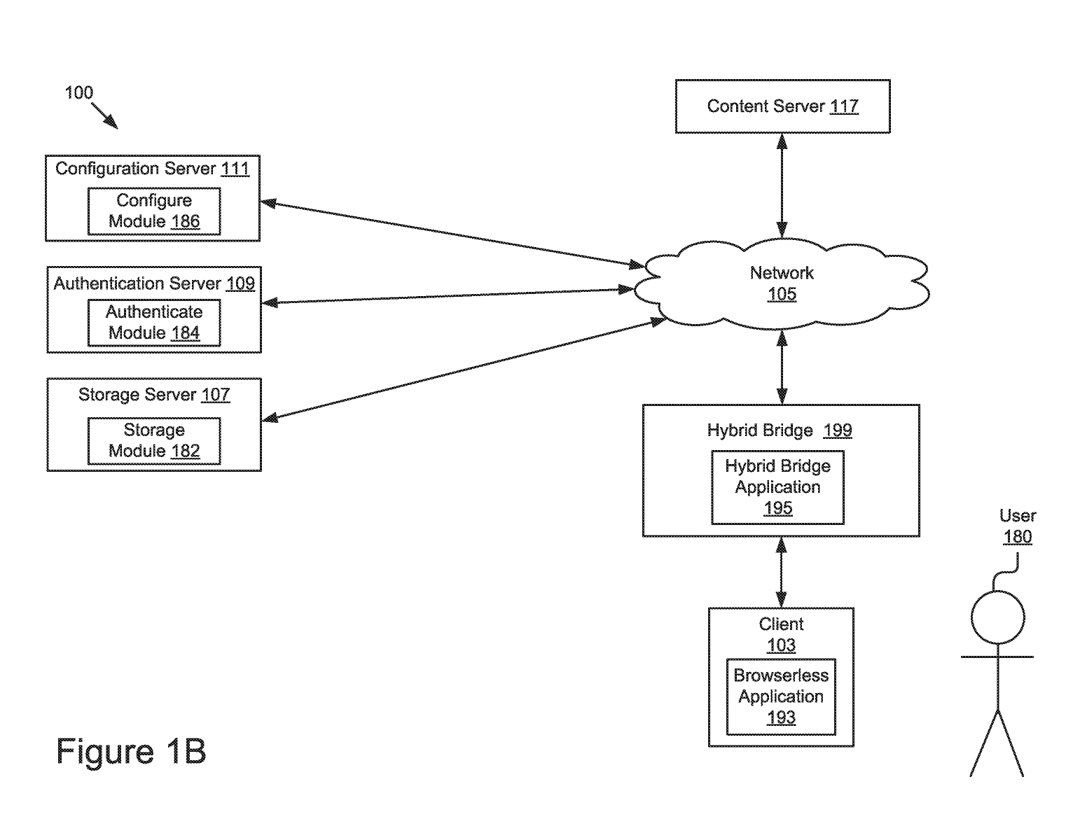

FIG. 1 illustrates a block diagram of some implementations of a system 100 for providing browserless file storage and synchronization. The system 100 includes a configuration server 111, an authentication server 109, a storage server 107, a firewall 113, a content server 117, a router 115, a hybrid bridge 199 and a client 103. One or more of these elements of the system 100 may be communicatively coupled to a network 105.

While FIG. 1 illustrates one configuration server 111, one authentication server 109, one storage server 107, one firewall 113, one content server 117, one router 115, one hybrid bridge 199 and one client 103, the disclosure applies to a system architecture including one or more configuration servers 111, one or more authentication servers 109, one or more storage servers 107, one or more firewalls 113, one or more content servers 117, one or more routers 115, one or more hybrid bridges 199 and one or more clients 103. Furthermore, although FIG. 1 illustrates one network 105 coupled to the entities of the system 100, in practice one or more networks 105 of various types may be connected to these entities.

The network 105 may be a conventional type, wired or wireless, and may have numerous different configurations including a star configuration, token ring configuration, or other configurations. Furthermore, the network 105 may include a local area network (LAN), a wide area network (WAN) (e.g., the Internet), or other interconnected data paths across which multiple devices may communicate. In some implementations, the network 105 may be a peer-to-peer network. The network 105 may also be coupled to or includes portions of a telecommunications network for sending data in a variety of different communication protocols. In some implementations, the network 105 includes Bluetooth® communication networks or a cellular communications network for sending and receiving data including via short messaging service (SMS), multimedia messaging service (MMS), hypertext transfer protocol (HTTP), direct data connection, WAP, e-mail, etc. The network 105 may be a mobile data network, for example, 3G, 4G, LTE, Voice-over-LTE (“VoLTE”) or any other mobile data network or combination of mobile data networks. In some implementations, the network 105 may be a combination of different networks.

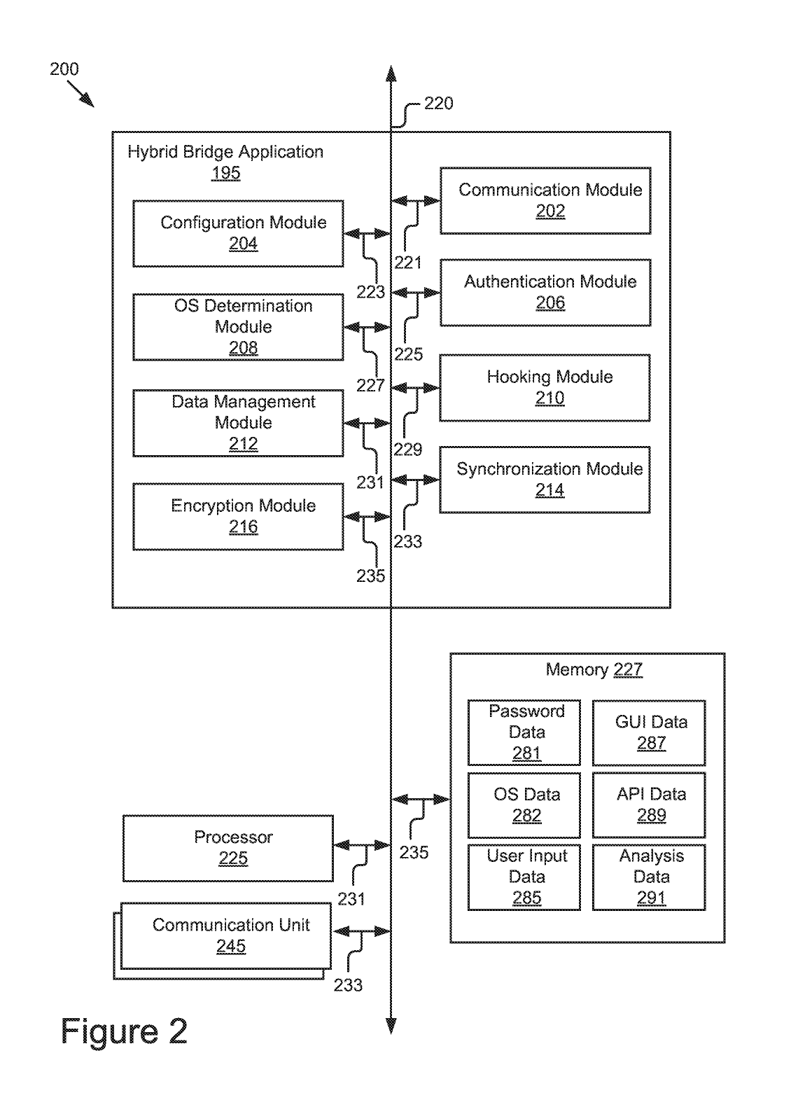

The user 180 may be a human user of the client 103. The client 103 may be any processor-based computer device. For example, the client 103 may be a personal computer, laptop, tablet computer, smartphone, smartwatch, set-top box or any connected device including a processor and a communication unit for communicatively coupling to the hybrid bridge 199. An example of the processor and the communication unit are described below with reference to FIG. 2 and elements 225 and 245. The communicative coupling between the client 103 and the hybrid bridge 199 may include wireless communication or a hardwired coupling between the client 103 and the hybrid bridge 199.

In some implementations, one or more clients 103 are communicatively coupled to the hybrid bridge 199 at the same time. The clients 103 communicatively coupled to the hybrid bridge 199 may be of different types. For example, one or more laptops, one or more tablet computers and one or more smartphones may be communicatively coupled to the hybrid bridge 199 at the same time.

In some implementations, one or more of the clients 103 communicatively coupled to the hybrid bridge 199 may be associated with the user 180. For example, their security credentials for accessing the hybrid bridge 199 may be associated with the user 180.

Some browser-based file sharing and synchronization services (e.g., Dropbox™, Box™, OneDrive™) may include a special-purpose desktop application configured to enable users to access their service. A user may click an icon associated with this application and cause their client to open a folder that is associated with the browser-based file sharing and synchronization service. This folder may include files that are all updated through synchronization with the browser-based file sharing and synchronization service. This synchronization occurs as a background process via a browser installed in the client. However, since the browser has various security loopholes, synchronizing the folder associated with the special-purpose desktop application in this manner poses a security risk. A hybrid bridge 199 overcomes this deficiency in part by interacting with a browserless application 193 that may be included in the client 103. The browserless application 193 will not be described according to some implementations.

The browserless application 193 may include code and routines for opening, displaying or editing one or more files. The browserless application 193 may be any application accessible by the client 103 that does not include a browser, browser functionality or application programming interfaces (“API” or “APIs”) for communicating with one or more of the servers 107, 109, 111, 117. For example, the browserless application 193 may include a word processor, spreadsheet application, audio or video content player, image editor or any other application that does not include a browser. In some implementations, the browserless application 193 is stored on a non-transitory memory and executed by a processor of the client 103.

In some implementations, the browserless application 193 is not a special-purpose desktop application configured to communicate with one or more of the servers 107, 109, 111, 117. In some implementations, the browserless application 193 is not a special-purpose desktop application. For example, the hybrid bridge 199 is a browserless device configured to enable the client 103 to access a browserless file sharing and synchronization service (as opposed to a browser-based file sharing and synchronization service) and the browserless application 193 is not a special-purpose desktop application configured to enable the user 180 to access a browser-based file sharing and synchronization service. Similarly, in some implementations the browserless application 193 is not a special-purpose desktop application configured to enable the client 103 to access a browserless file sharing and synchronization service or a browser-based file sharing and synchronization service.

The hybrid bridge 199 is a browserless device configured to enable the client 103 to securely access a browserless file sharing and synchronization service. In some implementations, the hybrid bridge 199 is a hardware device. The hybrid bridge 199 may be a handheld mobile device including a battery. The hybrid bridge 199 may be configured to wirelessly connect to the network 105 via the hybrid bridge 199. The hybrid bridge 199 may also include hardware and software for communicatively coupling to one or more of the client 103, the router 115 or the network 105 via a hardwired communicative coupling such as an Ethernet connection. The hybrid bridge 199 may operate on the client-side of the network 105. The hybrid bridge 199 may act as a proxy for one or more clients 103 on the client-side of the network 105. For example, a user 180 of the client 103 may provide a password to log in to the hybrid bridge 199. The hybrid bridge 199 may be configured to access the network 105 via the router 115. In this way, the client 103 may access the network 105 without being communicatively coupled to the network 105 or the router 115. The hybrid bridge 199 will be described in more detail below with reference to FIGS. 2-6D.

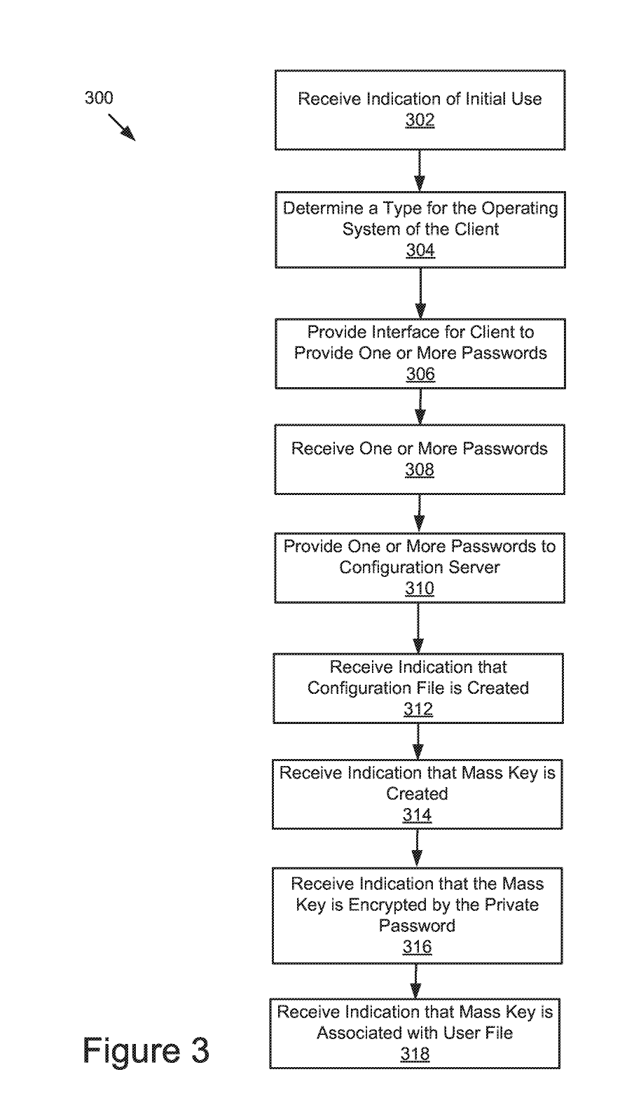

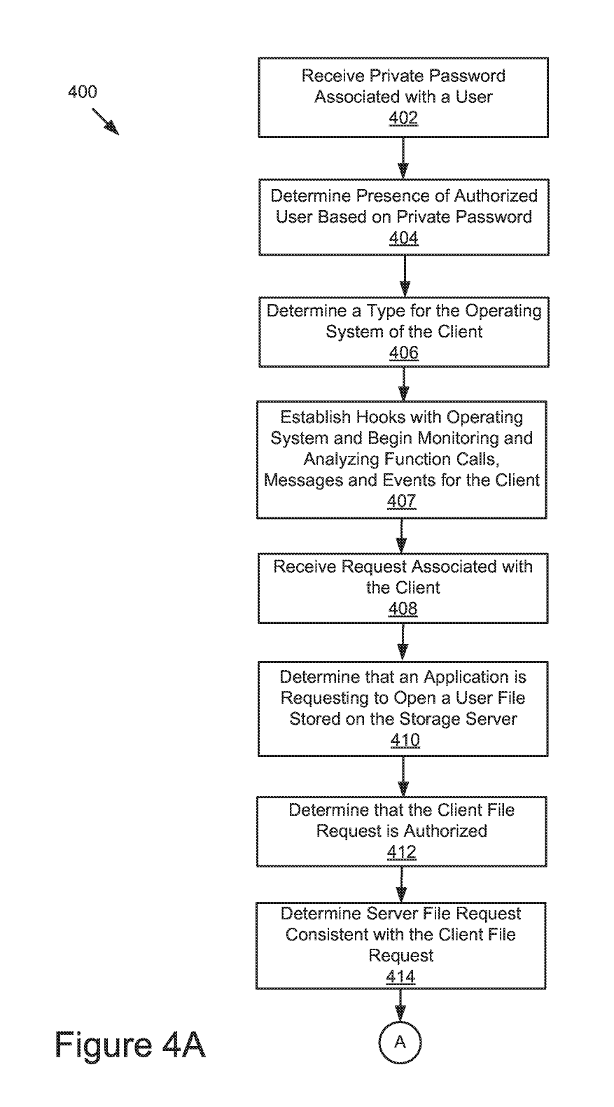

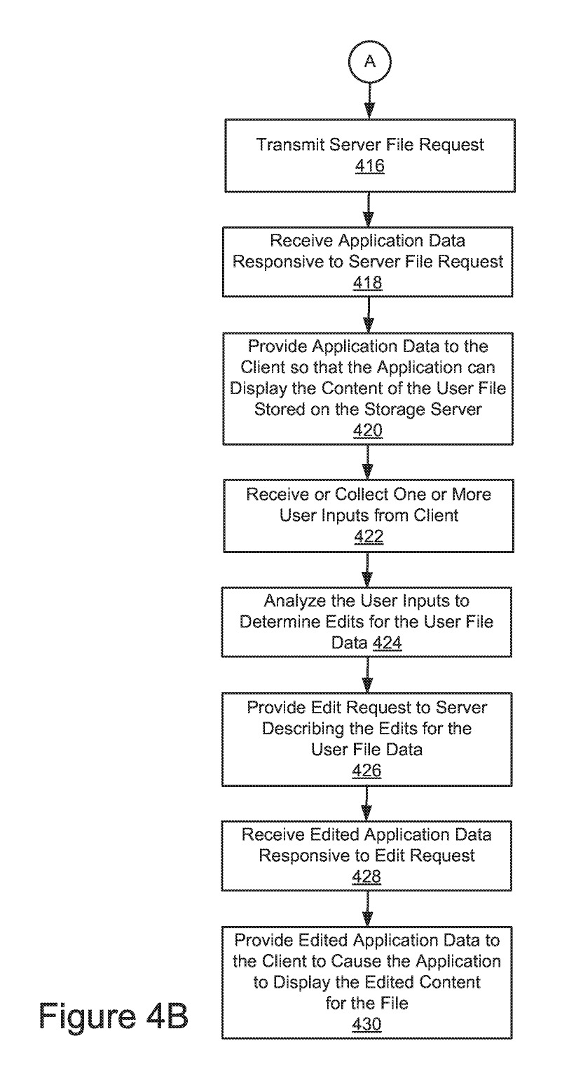

The hybrid bridge 199 may include a hybrid bridge application 195. The hybrid bridge application 195 may include code and routines configured to enable the client 103 to securely access the browserless file sharing and synchronization service. In some implementations, the hybrid bridge application 195 includes code and routines configured to perform one or more of the steps of methods 300 and 400 described below with reference to FIGS. 3, 4A and 4B when executed by a processor of the hybrid bridge 199, such processor 225 described below with reference to FIG. 2. The hybrid bridge application 195 will be described in more detail below with reference to FIGS. 2-6D.

The router 115 may include a networking device for enabling the hardware bridge 199 and one or more devices communicatively coupled to the hardware bridge 199 to access the network 105. The router 115 may receive data packets from the network 105. The data packets received from the network 105 may be associated with one or more of the storage server 107, authentication server 109, configuration server 111, firewall 113 and the content server 117. The router 115 may forward data packets to the network 105. The data packets forwarded to the network 105 may be associated with the hybrid bridge 199 and one or more clients 103. In some implementations, router 115 may be a specialized hardware networking device.

The network 105 may be a conventional type, wired or wireless, and may have numerous different configurations including a star configuration, token ring configuration, or other configurations. Furthermore, the network 105 may include a local area network (LAN), a wide area network (WAN) (e.g., the Internet), or other interconnected data paths across which multiple devices may communicate. In some implementations, the network 105 may be a peer-to-peer network. The network 105 may also be coupled to or include portions of a telecommunications network for sending data in a variety of different communication protocols. In some implementations, the network 105 includes Bluetooth® communication networks or a cellular communications network for sending and receiving data including via short messaging service (SMS), multimedia messaging service (MMS), hypertext transfer protocol (HTTP), direct data connection, WAP, e-mail, etc. The network 105 may be a mobile data network such as 3G, 4G, LTE, Voice-over-LTE (“VoLTE”), or any other mobile data network or combination of mobile data networks.

The content server 117 may be a processor-based computing device that includes a tangible or non-transitory memory and a processor. For example, the content server 117 may be a laptop computer, a desktop computer or other electronic device capable of accessing the network 105. In some implementations, the content server 117 may be configured to provide a browser-based file sharing and synchronization service. For example, the content server 117 may provide a browser-based file sharing and synchronization service such as Dropbox™, Box™, OneDrive™, etc. In some implementations content server 117 does not provide a browserless file sharing and synchronization service.

The firewall 113 may include a network security system that may control the incoming and outgoing network traffic for the storage server 107, authentication server 109 and the configuration server 111. The firewall may control the network traffic for these servers 107, 109, 111 based on a rule set. In some implementations, the firewall 113 may be a specialized hardware device configured to provide the network security functionality described above with regards to the firewall 113. In some implementations, the firewall 113 may include code and routines stored and executed by a processor-based computing device, and configured to provide the network security functionality described above with regards to the firewall 113.

In some implementations, the storage server 107, authentication server 109 and the configuration server 111 may be configured to work together to provide the browserless file sharing and synchronization service described in this disclosure. FIGS. 1A and 1B depict implementations where the functionality of the storage server 107, authentication server 109 and the configuration server 111 are provided by three different servers. In some implementations, the functionality of the storage server 107, authentication server 109 and the configuration server 111 may be combined into one or more servers. In some implementations, the functionality of one or more of the storage server 107, authentication server 109 and the configuration server 111 may be distributed across one or more servers.

The storage server 107 may include a processor-based computing device for encrypting and storing one or more encrypted user files as part of the browserless file sharing and synchronization service accessible via the hybrid bridge 199. The storage server 107 may include a tangible or non-transitory memory and a processor. For example, the storage server 107 may be a laptop computer, a desktop computer or other electronic device capable of accessing the network 105. The non-transitory memory of the storage server 107 may include a storage array for storing the encrypted user files.

In some implementations, the storage server 107 is communicatively coupled to the firewall 113. In implementations including the firewall 113, the storage server 107 may communicate with the network 105, the authentication server 109 and the configuration server 111 via the firewall 113. The storage server 107 may send data to the network 105 via the firewall 113. The storage server 107 may also receive data from the network 105 via the firewall 113. The storage server 107 may include hardware and software for communicating with the network 105 without the firewall 113.

The storage server 107 may include a storage module 182. The storage module 182 may include code and routines configured to provide the functionality of the storage server 107. For example, the storage module 182 may include code and routines configured to encrypt user file data and store the user file data on the non-transitory memory of the storage server 107. In some implementations, the storage module 182 may include code and routines to generate application data and edited application data as described below with reference to FIGS. 4A and 4B.

In some implementations, the processor and the non-transitory memory of the storage server 107 may be similar to the processor 225 and the memory 227 described below with reference to FIG. 2. The processor of the storage server 107 may be configured to access and execute the code and routines of the storage module 182 to provide the functionality of the storage server 107. The storage server 107 and the storage module 182 will be described in more detail below.

The authentication server 109 may include a processor-based computing device for receiving login information including a user name and one or more passwords, analyzing the one or more passwords based on the configuration file associated with the user name included in the login information and authenticating one or more users 180 of the hybrid bridge 199 based on the login information and a configuration file associated with the user name included in the login information. The configuration file may be stored on the configuration server 111. The configuration file will be described in more detail below. The authentication server 109 may include a tangible or non-transitory memory and a processor. For example, the authentication server 109 may be a laptop computer, a desktop computer or other electronic device capable of accessing the network 105.

In some implementations, the authentication server 109 is communicatively coupled to the firewall 113. In implementations including the firewall 113, the authentication server 109 may communicate with the network 105, the storage server 107 and the configuration server 111 via the firewall 113. The authentication server 109 may send data to the network 105 via the firewall 113. The authentication server 109 may also receive data from the network 105 via the firewall 113. The authentication server 109 may include hardware and software for communicating with the network 105 without the firewall 113.

The authentication server 109 may include an authenticate module 184. The authenticate module 184 may include code and routines configured to provide the functionality of the authentication server 109. For example, the authenticate module 184 may include code and routines configured to receive login information including a user name and one or more passwords, analyze the one or more passwords based on the configuration file associated with the user name included in the login information and authenticate one or more users 180 of the hybrid bridge 199 based on the login information and the configuration file associated with the user name included in the login information.

In some implementations, the processor and the non-transitory memory of the authentication server 109 may be similar to the processor 225 and the memory 227 described below with reference to FIG. 2. The processor of the authentication server 109 may be configured to access and execute the code and routines of the authenticate module 184 to provide the functionality of the authentication server 109. The authentication server 109 and the authenticate module 184 will be described in more detail below.

The configuration server 111 may include a processor-based computing device for setting up the configuration file for the hybrid bridge 199, managing and storing the configuration file and bricking the hybrid bridge 199 responsive to receiving instructions to do so from the user 180 of the hybrid bridge 199. The configuration file will be described in more detail below. The configuration server 111 may include a tangible or non-transitory memory and a processor. For example, the configuration server 111 may be a laptop computer, a desktop computer or other electronic device capable of accessing the network 105. The configuration file may be stored in the non-transitory memory of the configuration server 111 and accessible by the processor of the configuration server 111.

In some implementations, the configuration server 111 is communicatively coupled to the firewall 113. In implementations including the firewall 113, the configuration server 111 may communicate with the network 105, the storage server 107 and the authentication server 109 via the firewall 113. The configuration server 111 may send data to the network 105 via the firewall 113. The configuration server 111 may also receive data from the network 105 via the firewall 113. The configuration server 111 may include hardware and software for communicating with the network 105 without the firewall 113.

The configuration server 111 may include a configure module 186. The configure module 186 may include code and routines configured to provide the functionality of the configuration server 111. For example, the configure module 186 may include code and routines configured to set up the configuration file for the hybrid bridge 199, manage and store the configuration file and brick the hybrid bridge 199 responsive to receiving instructions to do so from the user 180 of the hybrid bridge 199.

In some implementations, the processor and the non-transitory memory of the configuration server 111 may be similar to the processor 225 and the memory 227 described below with reference to FIG. 2. The processor of the configuration server 111 may be configured to access and execute the code and routines of the configure module 186 to provide the functionality of the configuration server 111. The configuration server 111 and the configure module 186 will be described in more detail below.

In some implementations, one or more of the storage server 107, authentication server 109, the configuration server 111 and the firewall 113 may be configured to transmit encrypted communications to the hybrid bridge 199 via the network 105. These communications are not decrypted by the client 103. Instead, the hybrid bridge 199 and the browserless file storage and synchronization service are configured so that (1) all communications transmitted by the storage server 107, authentication server 109, the configuration server 111 and the firewall 113 to the hybrid bridge 199 are encrypted and (2) the hybrid bridge 199 always decrypts all communications received from the storage server 107, authentication server 109, the configuration server 111 and the firewall 113. By comparison, browser-based file storage and synchronization services are designed so that encrypted communications are decrypted by the browser of the client. However, since any open tab in the browser may monitor and intercept data associated with other tabs of the browser, allowing the browser to decrypt encrypted communications poses a significant security risk. The hybrid bridge 199 beneficially solves this security risk by always decrypting these encrypted communications at the hybrid bridge 199 before forwarding a decrypted version of the data included in the encrypted communication to the client 103.

The hybrid bridge 199 may be configured to transmit encrypted communications to one or more of the storage server 107, authentication server 109, the configuration server 111 and the firewall via the network 105. These communications are not encrypted by the client 103. Instead, the hybrid bridge 199 and the browserless file storage and synchronization service are configured so that (1) the hybrid bridge 199 always encrypts all communications transmitted to one or more of the storage server 107, authentication server 109, the configuration server 111 and the firewall 113. By comparison, browser-based file storage and synchronization services are designed so that communications are encrypted by the browser of the client. However, since any open tab in the browser may monitor and intercept data associated with other tabs of the browser, allowing the browser to encrypt communications poses a significant security risk. The hybrid bridge 199 beneficially solves this security risk by always encrypting communications at the hybrid bridge 199 before forwarding the communication to one or more of the storage server 107, authentication server 109, the configuration server 111 and the firewall 113 via the network 105.

In some implementations, the encryption used by the storage server 107, authentication server 109, configuration server 111, firewall 113 and the hybrid bridge 199 may be based on industry standards such as Samba, among other standards.

In some implementations, the configuration server 111 may be configured to manage configuration files for one or more hybrid bridges 199. For example, as described below with reference to method 300 of FIG. 3, a user 180 of the hybrid bridge 199 may provide inputs to establish one or more passwords for the hybrid bridge 199. The one or more passwords may be included in the configuration file associated with the hybrid bridge 199.

In some implementations, the hybrid bridge 199 may be associated with three different passwords: (1) a private password; (2) a back-office password; and (3) a recovery password. As will be explained in more detail below, the configuration server 111 may store the back-office password and the recovery password in the configuration file associated with the hybrid bridge 199.

The private password may include a password for enabling the user 180 to access one or more of user files. In some implementations, the private password may include an initial password provided by the user 180 during the initial use of the hybrid bridge 199. In some implementations, accessing a user file may include viewing and editing the content of the user file using the client 103 and the hybrid bridge 199. The private password will be described in more detail below.

The back-office password may include a password for enabling the use 180 to view and modify the configuration file for the hybrid bridge 199. For example, the user 180 may provide the back office password using a portal or browser of the client 103, and then view a graphical user interface (GUI) displaying the content of the configuration file for the hybrid bridge. The user 180 may use the client 103 and the GUI to edit the content of the configuration file. The back-office password will be described in more detail below.

The recovery password may include a password for enabling the user 180 to access the one or more user files in the event that the private password is lost or stolen.

The storage server 107 may encrypt the user files using a mass key. The storage server 107 may store the encrypted user files on the non-transitory memory of the storage server 107. For example, the storage server 107 may store the encrypted user files on the storage array of the non-transitory memory.

The one or more encrypted user files may be stored on the storage server 107 as file data. The file data may include data describing the user files.

In some implementations, the storage server 107 is configured so that the file data describing the user files is only accessible from the storage server 107. For example, the storage server 107 is configured so that the file data is never transmitted to another entity of the system 100. In this way, the file data may be kept confidential for the user 180.

The configuration server 111 may be configured so that the configuration file is only modifiable by an entity that has provided the back-office password during an authentication process implemented by the authentication server 109. The configuration file may be associated with the hybrid bridge 199 to configure the operation of the hybrid bridge 199. For example, the hybrid bridge 199 may include device level settings and permissions for different clients 103. Similarly, the hybrid bridge 199 may include application-specific settings and permissions for different applications associated with the client 103. The settings and permissions may be described by configuration data included in the configuration file stored by the configuration server 111. In some implementations, the configuration data may only be accessible and modifiable by an entity that provides the back-office password associated with the hybrid bridge 199 which is associated with the configuration data.

In some implementations, a user 180 may determine that they want to cause the configuration server 111 to brick the hybrid bridge 199. For example, the hybrid bridge 199 may have been lost or stolen and the user 180 may want to brick the hybrid bridge 199 to protect the confidentiality of the user files. The user 180 may use a browser stored on the client 103 to provide the back-office password and access the configuration file for the lost or stolen hybrid bridge. The configuration server 111 may include functionality for causing the browser to display a GUI for enabling the user 180 to cause the configuration server 111 to brick the hybrid bridge 199 associated with the back-office password provided by the user 180. The user 180 may provide inputs to cause the configuration server 111 to transmit a bricking signal to the hybrid bridge 199. The hybrid bridge 199 will receive the bricking signal. The hybrid bridge 199 may then take steps to erase data stored on the hybrid bridge 199 and render the hybrid bridge 199 nonfunctional.

In some implementations, one or more of the hybrid bridge application 195, storage module 182, authenticate module 184 and configure module 186 may be implemented using hardware including a field-programmable gate array (“FPGA”) or an application-specific integrated circuit (“ASIC”). In some other implementations, one or more of the hybrid bridge application 195, storage module 182, authenticate module 184 and configure module 186 may be implemented using a combination of hardware and software. One or more of the hybrid bridge application 195, storage module 182, authenticate module 184 and configure module 186 may be stored in a combination of the devices and servers, or in one of the devices or servers.

Referring now to FIG. 1B, depicted is an example of the browserless file storage and synchronization system 100 that does not include the firewall 113 or the router 115. The other elements of the system 100 are the same as those described above for FIG. 1A, and so, the descriptions for these elements will not be repeated here.

### Example Hybrid Bridge System

Referring now to FIG. 2, an example of the hybrid bridge application 195 is shown in more detail. FIG. 2 is a block diagram of a hybrid bridge system 200. The system 200 may be the hybrid bridge 199 illustrated in FIGS. 1A and 1B. The system 200 cannot include the client 103 and the client 103 cannot include the system 200. The system 200 may include the hybrid bridge application 195, a processor 225, a communication unit 245 and a memory 227 according to some examples. The components of the system 200 are communicatively coupled by a bus 220. Although only one hybrid bridge application 195, one processor 225, one communication unit 245 and one memory 227 are depicted in FIG. 2, in practice the system 200 may include two or more hybrid bridge applications 195, two or more processors 225, two or more communication units 245 and two or more memories 227. For example, with reference to FIG. 1B, the system 200 may be the hybrid bridge 199 and include a communication unit 245 for managing communications between the hybrid bridge 199 and the network 105 and a second communication unit 245 for managing communications between the hybrid bridge 199 and the client 103.

The processor 225 includes an arithmetic logic unit, a microprocessor, a general-purpose controller, or some other processor array to perform computations and provide electronic display signals to a display device. The processor 225 is coupled to the bus 220 for communication with the other components via a signal line 231. The processor 225 processes data signals and may include various computing architectures including a complex instruction set computer (CISC) architecture, a reduced instruction set computer (RISC) architecture, or an architecture implementing a combination of instruction sets. Although FIG. 2 includes a single processor 225, multiple processors 225 may be included. Other processors, operating systems, sensors, displays, and physical configurations may be possible.

In one implementation, the processor 225 is programmed to execute one or more steps of a method. For example, the processor 225 is programmed to execute one or more steps of methods 300, 400 or 500 described below with reference to FIGS. 3, 4A, 4B and 5. The processor 225 of the system 200 may include hardware circuitry configured for execution of one or more of the steps of the methods 300, 400 or 500.

The memory 227 is a tangible or non-transitory computer-readable memory. The memory 227 stores instructions or data that may be executed by the processor 225. The memory 227 is coupled to the bus 220 for communication with the other components via a signal line 235. The instructions or data stored on the memory 227 may include code for performing the techniques described herein. The memory 227 may be a dynamic random access memory (DRAM) device, a static random access memory (SRAM) device, flash memory, or some other memory device. In some implementations, the memory 227 also includes a non-volatile memory or similar permanent storage device and media including a hard disk drive, a floppy disk drive, a CD-ROM device, a DVD-ROM device, a DVD-RAM device, a DVD-RW device, a flash memory device, or some other mass storage device for storing information on a more permanent basis.

As illustrated in FIG. 2, the memory 227 stores password data 281, operating system data 282 (“OS data 282”), user input data 285, GUI data 287, API data 289 and analysis data 291. The memory 227 may also store other data for providing the functionality described herein.

The password data 281 may include one or more passwords provided by the user 180. For example, the password data 281 may describe one or more of the private password, back-office password, the recovery password and the new private password.

The OS data 282 may include data used to determine the operating system type for the client 103. The OS data 282 may include hook data for establishing one or more hooks with the client 103. The hook data may include hooks for any type of operating system for any type of client 103. The hook data may include hook data for establishing hooks for one or more different operating systems.

The user input data 285 may include data describing one or more inputs received from the client 103. The inputs may be provided to the client 103 by the user 180. For example, the user 180 may provide inputs to open a document stored as file data by the storage server 107. These inputs may be received by the hybrid bridge 199 and stored as user input data 285. As will be described below, the hybrid bridge may select analysis data 291 based on the operating system type for the client 103, and then analyze the user input data 285 based on the selected analysis data 291 to determine that the user input data 285 indicates that the user 180 wants to open the document stored by the storage server 107.

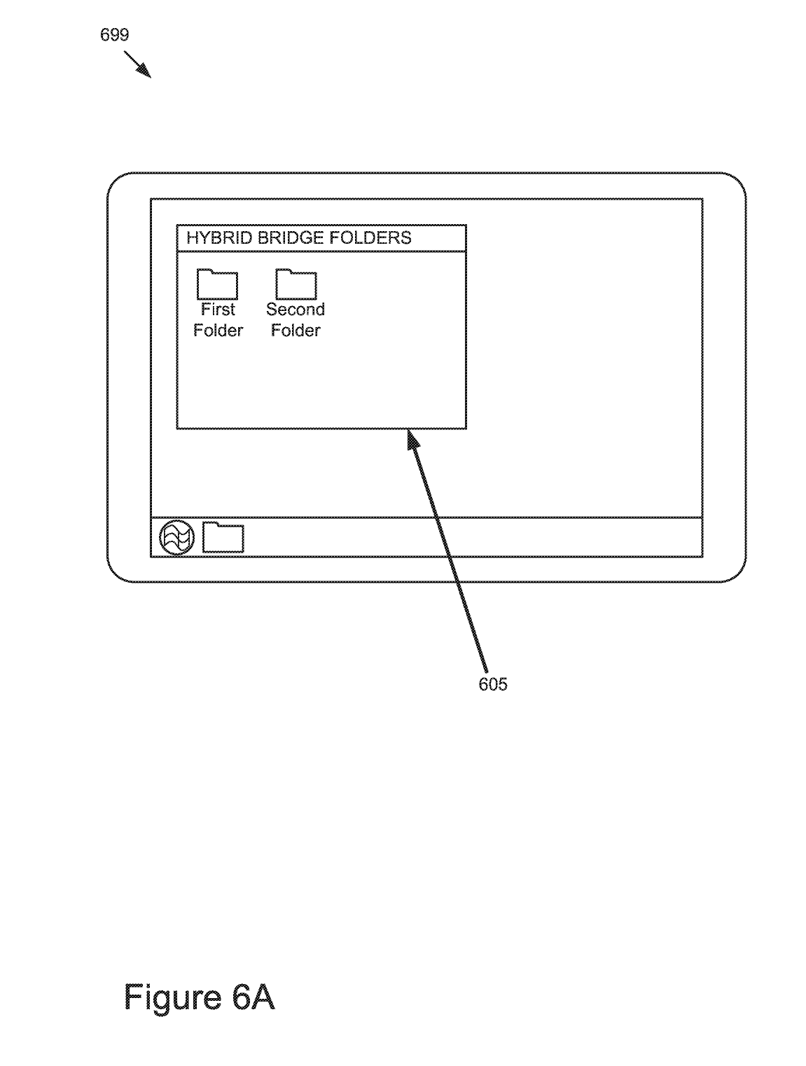

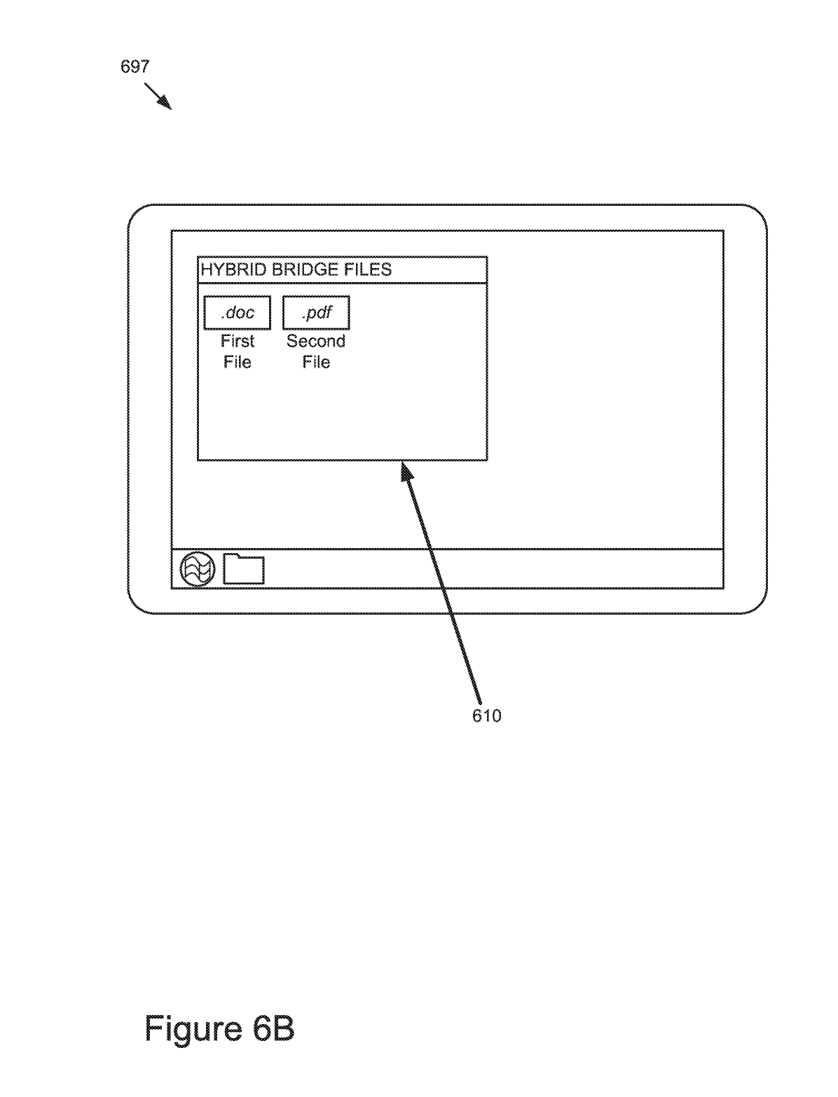

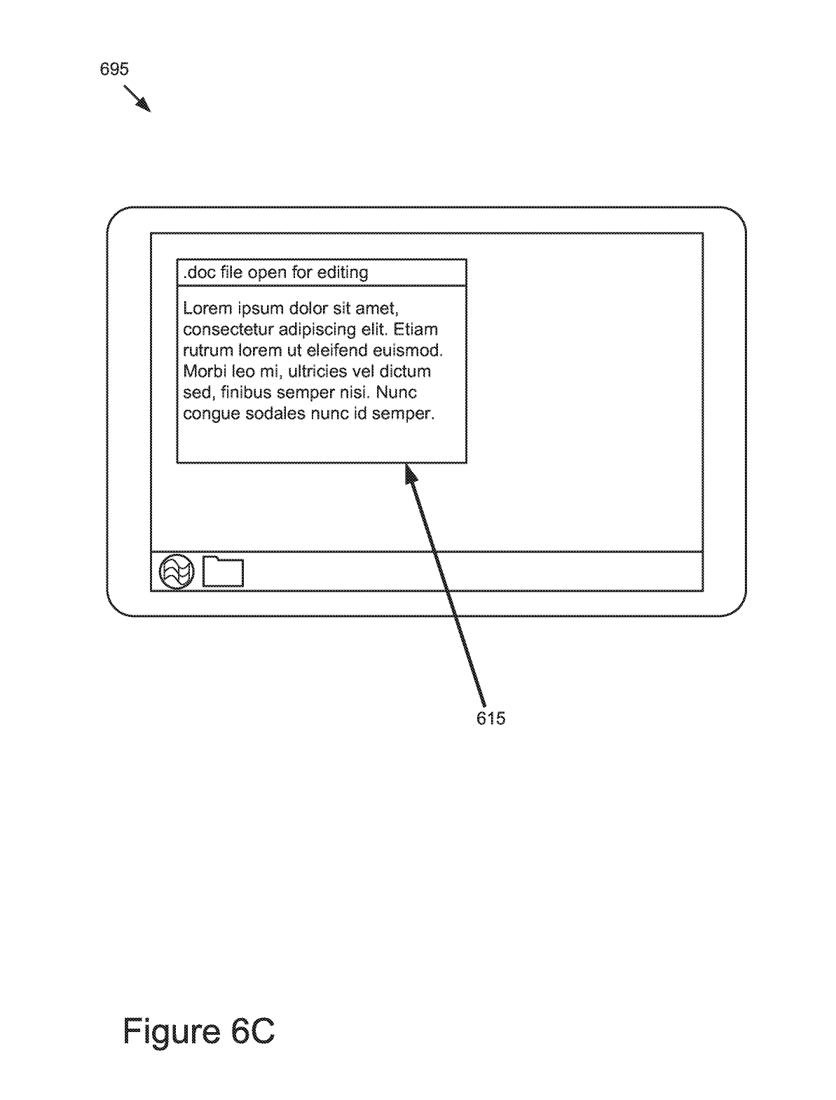

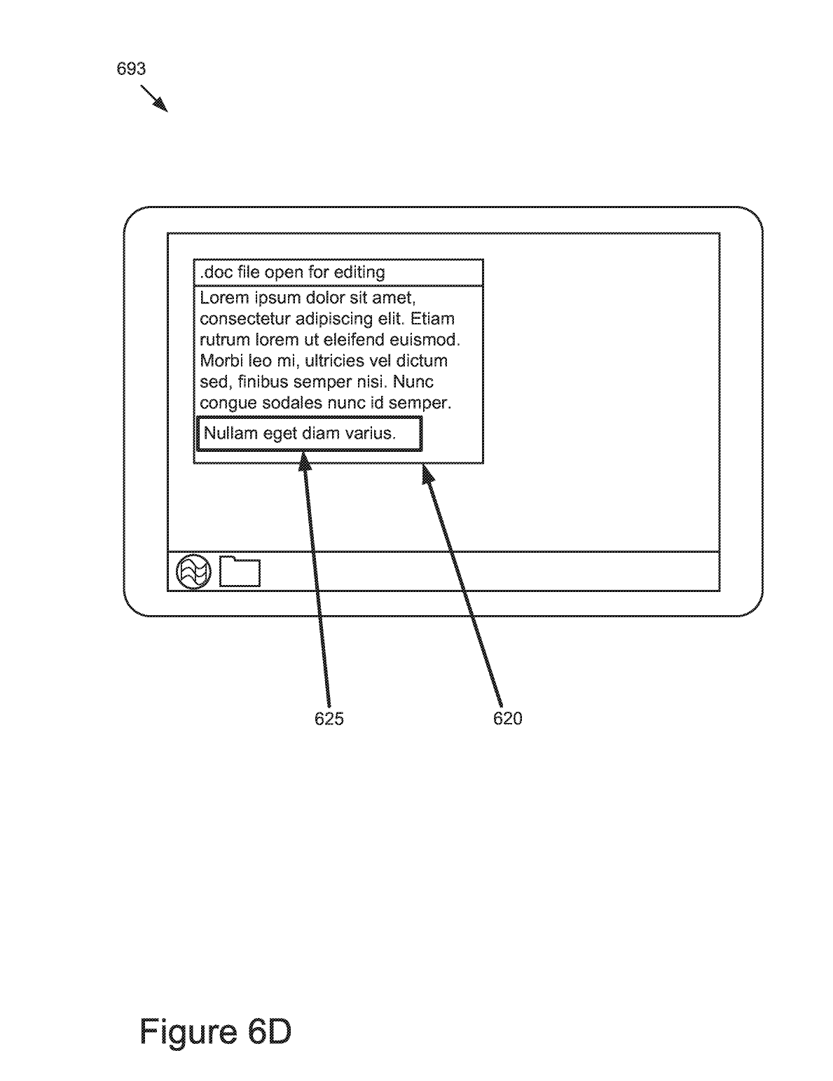

The GUI data 287 includes data for displaying GUIs or graphics on a display associated with the client 103. For example, GUI data 287 may be used to provide a graphical display of a document that is stored on the storage server 107. Although the document remains stored on the storage server 107, the client 103 may display a graphical display of the document so that the user 180 may view and edit the document. An example of the graphical display of a document for viewing and editing by the user 180 of the client 103 is shown by elements 699, 697, 695 and 693 of FIGS. 6A-6D. The GUI data 287 may be received from one or more of the firewall 113, the storage server 107, the authentication server 109 and the configuration server 111. In some implementations, one or more of the storage module 182, the authenticate module 184 and the configure module 186 may include code and routines for generating the GUI data 287. In some implementations, one of the modules of the hybrid bridge application 195 may include code and routines for generating some or all of the GUI data 287.

The API data 289 includes data for enabling the system to communicate with one or more of the firewall 113, storage server 107, authentication server 109 and the configuration server 111. The API data 289 cannot be stored on the client 103.

The analysis data 291 may include data for analyzing user input data 285 to determine one or more actions based on the user input data 285. The analysis data 291 may include data for analyzing user input data 285 received from various different operating systems for the client 103.

In one implementation, the analysis data 291 may include one or more tables for analyzing the user input data 285. Each table may be specific to a different operating system for the client 103. For example, the analysis data 291 may include a first table for clients 103 operating Windows 7, a second table for clients 103 operating Windows 10, a third table for clients 103 operating Windows Phone, a fourth table for clients 103 operating OS X, a fifth table for clients 103 operating iOS, any number of tables for clients 103 operating variations of Linux (including mobile operating systems such as Android), etc. The analysis data 291 may include a different table for each operating system in existence.

In some implementations, a table included in the user input data 285 may include a first column describing a combination of user inputs included in the user input data. Different combinations of user inputs may be stored in different rows of the column. A second column of the table may describe one or more user actions corresponding to the user inputs stored in the first column. The second column may include different rows corresponding to the rows of the first column. The system 200 may use these columns to cross reference the user input data 285 and determine one or more actions corresponding to the user inputs described by the user input data 285. For example, the system 200 may determine which type of operating system is being used by the client 103. The system 200 may select a table from the analysis data 291 based on the type of operating system used by the client 103. The system 200 may use the selected table to analyze user input data 285 received from the client 103. The system 200 may cross-reference the user input data 285 using the first row and the second row of the selected table to determine one or more actions corresponding to the user input data 285. The actions described by the analysis data 291 may include any action or combination of actions that a client 103 may take with regards to one or more files regardless of the file type.

In some implementations, one or more of the password data 281, the OS data 282, the user input data 285, the GUI data 287, the API data 289 and the analysis data 291 may be encrypted while stored on the memory 227.

The communication unit 245 transmits and receives data to and from different elements. For example, the communication unit 245 transmits and receives data to and from one or more elements of the system 100 described above with reference to FIG. 1A or 1B. The communication unit 245 is coupled to the bus 220 via a signal line 233. In some implementations, the communication unit 245 includes a port for direct physical connection to the network 105 or to another communication channel. For example, the communication unit 245 includes a USB, SD, CAT-5, or similar port for wired communication with other entities in the system 100. In some implementations, the communication unit 245 includes a wireless transceiver for exchanging data with other entities in the system 100 or other communication channels using one or more wireless communication methods, including IEEE 802.11, IEEE 802.16, Bluetooth®, Bluetooth Low Energy® or another suitable wireless communication method.

In some implementations, the communication unit 245 includes a cellular communications transceiver for sending and receiving data over a cellular communications network including via short messaging service (SMS), multimedia messaging service (MMS), hypertext transfer protocol (HTTP), direct data connection, WAP, e-mail, or another suitable type of electronic communication. In some implementations, the communication unit 245 includes a wired port and a wireless transceiver. The communication unit 245 may also provide other conventional connections to the network 105 for distribution of files or media objects using standard network protocols including TCP/IP, HTTP, HTTPS, and SMTP, etc.

In the illustrated implementation shown in FIG. 2, the hybrid bridge application 195 includes a communication module 202, a configuration module 204, an authentication module 206, an operating system determination module 208 (“OS determination module 208”), a hooking module 210, a data management module 212, a synchronization module 214 and an encryption module 216. These modules of the hybrid bridge application 195 are communicatively coupled to each other via the bus 220.

In some implementations, the modules of the hybrid bridge application 195 may be stored in a single server or device. In some other implementations, modules of the hybrid bridge application 195 may be distributed and stored across multiple servers or devices. Furthermore, the separation of various components, modules, and servers in the implementations described herein should not be understood as requiring such separation in all implementations. In some implementations, the described components, modules, devices, or servers may generally be integrated together in a single component, module, device, or server.

In some implementations, each of the modules 202, 204, 206, 208, 210, 212, 214 and 216 in the hybrid bridge application 195 may be a set of instructions executable by the processor 225 to provide the functionality described below. In some other implementations, each of the modules 202, 204, 206, 208, 210, 212, 214 and 216 may be stored in the memory 227 and may be accessible and executable by the processor 225 of the system 200. Each of the modules 202, 204, 206, 208, 210, 212, 214 and 216 may be adapted for cooperation and communication with the processor 225 and other components of the system 200. In some implementations, each of the modules 202, 204, 206, 208, 210, 212, 214 and 216 may be adapted to function as one or more thin clients that are stored and executed by the processor 225 of the system 200.

The communication module 202 may be software including routines for handling communications between the hybrid bridge application 195 and other components of the system 200. In some implementations, the communication module 202 may be a set of instructions executable by the processor 225 to provide the functionality described below for handling communications. The communication module 202 may be communicatively coupled to the bus 220 via signal line 221.

The communication module 202 sends and receives data, via the communication unit 245, to and from one or more elements of the system 100. For example, the communication module 202 receives, via the communication unit 245, user input data 285 from the client 103. In another example, the communication module 202 receives, via the communication unit 245, GUI data 287 from one or more of the firewall 113, storage server 107, authentication server 109 or the configuration server 111.

In some implementations, the communication module 202 receives data from components of the hybrid bridge application 195 and stores the data in the memory 227. In some implementations, the communication module 202 retrieves data from the memory 227 and sends the data to one or more components of the hybrid bridge application 195.

In some implementations, the communication module 202 may handle communications between components of the hybrid bridge application 195. For example, the communication module 202 receives data from one module of the hybrid bridge application 195 and sends the data to another module of the hybrid bridge application 195.

The configuration module 204 may be software including routines for configuring the hybrid bridge system 200. For example, the hybrid bridge system 200 includes the hybrid bridge 199 and the configuration module 204 is configured to execute one or more steps of the method 300 described below with reference to FIG. 3.

The configuration module 204 may be communicatively coupled to the bus 220 via signal line 223.

The authentication module 206 may be software including routines for authenticating the identity of the user 180 of the client 103 based on one or more passwords. For example, the authentication module 206 receives an authentication input from the communication module 202. The authentication input may include data describing one or more passwords provided by the user 180 of the client 103. The user 180 may be attempting to use the hybrid bridge 199. The authentication module 206 causes the communication module 202 to retrieve the password data 281. The authentication module 206 receives the password data 281 from the communication module 202. The authentication module 206 analyzes the authentication input to determine whether to authenticate the user 180 of the client 103 based on whether the one or more passwords included in the authentication input match one or more of the passwords included in the password data 281. If a match is determined, then the authentication module 206 may authenticate the user 180 of the client 103 and enable the user 180 to use the hybrid bridge 199 for a period of time.

The authentication module 206 may be communicatively coupled to the bus 220 via signal line 225.

The OS determination module 208 may be software including routines for determining which operating system is being used by the client 103. For example, the OS determination module 208 receives a communication from the client 103 or router 115. The communication may include data indicating which operating system is used by the client 103. The OS determination module 208 analyzes the data included in the communication based on the OS data 282. The OS determination module 208 determines which operating system is being used by the client 103 based on the data included in the communication and the OS data 282.

The OS determination module 208 may be communicatively coupled to the bus 220 via signal line 227.

The hooking module 210 may be software including routines for establishing one or more hooks with the client 103. For example, the hooking module 210 may select data from the OS data 282 for establishing one or more hooks for the client 103 based on the type of operating system used by the client 103. The hooking module 210 may establish one or more hooks with the operating system used by the client 103.

Some operating systems may require the user 180 to reconfigure the settings of the client 103 before the hooks may be established. For example, Windows operating systems prior to Windows 10 may require a firewall setting or some other setting be reconfigured to allow the hooking module 210 to establish the one or more hooks for the client 103.

The hooking module 210 may be communicatively coupled to the bus 220 via signal line 229.

The data management module 212 may be software including routines for monitoring and analyzing one or more function calls, messages and events for the client 103 based on the one or more hooks. For example, the data management module 212 monitors the one or more function calls, messages and events for the client 103 based on the one or more hooks. The data management module 212 may collect user input data 285 based on the one or more hooks. The data management module 212 may analyze the user input data 285 based on the analysis data 291.

The data management module 212 may be communicatively coupled to the bus 220 via signal line 231.

The synchronization module 214 may be software including routines for determining communications transmitted to the network 105 or router 115. The communications may be configured to update the file data stored by the storage server 107 based on the user input data 285. For example, the data management module 212 may determine that user input data 285 collected using the one or more hooks indicates that a file should be edited. The synchronization module 214 may determine one or more communications including data to update the file data based on the user input data 285. As will be described below, the encryption module 216 may encrypt the communications created by the synchronization module 214. The encrypted communication may include data for causing the storage server 107 to update the file data for the file based on the one or more edits indicated by the user input data 285. In this way, the file data may be edited even though the file data is always stored on the storage server 107 and never stored on the system 200 or the client 103.

The synchronization module 214 may be communicatively coupled to the bus 220 via signal line 233.

The encryption module 216 may be software including routines for encrypting communications transmitted to the network 105 or router 115 and decrypting communications received from the network 105 or router 115. For example, the data management module 212 may determine that user input data 285 collected using the one or more hooks indicates that a file should be edited. The encryption module 216 may encrypt communications to be transmitted to the storage sever 107 via the network 105 or router 115. The encrypted communication may include data for causing the storage server 107 to update the file data for the file based on the one or more edits indicated by the user input data 285.

The encryption module 216 may be communicatively coupled to the bus 220 via signal line 235.

In some implementations, the configuration module 204 includes functionality to manage and apply device level settings to different clients 103 of the user 180. Similarly, the configuration module 204 may include functionality to manage and apply application-specific settings and permissions for different applications associated with the client 103. For example, assume that the user 180 has a mobile phone and a laptop. The user 180 may configure the system 200 so that the laptop has the ability to view and edit files stored by the storage server 107. The user 180 may configure the system 200 so that the mobile phone may view the content of files stored by the storage server 107, but not edit the content. The configuration module 204 may store data on the memory 227 necessary to implement one or more of the device level settings, the device level permissions, the application-specific settings and the application-specific settings. The data management module 212 may include functionality to implement one or more of the device level settings, the device level permissions, the application-specific settings and the application-specific settings when analyzing the user input data 285 as described above.

### Example Methods

Referring now to FIG. 3, an example method 300 for configuring a hybrid bridge 199 is described. In one implementation, the hybrid bridge 199 may be a processor-based computing device programmed to perform one of more steps of the method 300. For example, the hybrid bridge 199 may include the hybrid bridge system 200 described above with reference to FIG. 2. Although not explicitly stated in FIG. 3, in some implementations all transmissions to the hybrid bridge 199 are encrypted upon receipt and decrypted by the hybrid bridge 199 following receipt. Similarly, in some implementations all transmissions from the hybrid bridge 199 are encrypted prior to transmission by the hybrid bridge 199.

At block 302 an indication of initial use is received. This may indicate the initial use of the hybrid bridge 199. At block 304 a determination is made regarding the type of operating system used by the client 103. At block 306 an interface is provided for the client 103. The user 180 of the client 103 may use the interface to input one or more passwords. The one or more passwords may be associated with the configuration file of the hybrid bridge 199. At block 308 the one or more passwords are received. At block 310 the one or more passwords are provided to the configuration server 111. The passwords may include one or more of the following: (1) a private password; (2) a back-office password; and (3) a recovery password. The configuration server 111 may use the one or more passwords to create a configuration file for the hybrid bridge 199. At block 312 an indication may be received indicating that the configuration file is created. At block 314 an indication may be received indicating that a mass key is created for the hybrid bridge 199. At block 316 an indication may be received indicating that the mass key is encrypted using the private password. At block 318 an indication may be received indicating that the mass key is associated with one or more user files associated with the hybrid bridge 199. For example, prior to block 318 the hybrid bridge 199 may upload one or more user files to the storage server 107 and the storage server 107 may encrypt the file data describing the one or more user files using the mass key.

The method 300 may include additional or different blocks, and the blocks may be executed in a different order than described here. For example, the hybrid bridge 199 may receive one or more user inputs describing a user name or other login information for enabling the user 180 to login to the hybrid bridge 199 via the client 103. The hybrid bridge 199 may also receive one or more user inputs defining one or more device level settings for one or more different clients 103 of the user 180.

The hybrid bridge 199 may provide the configuration server 111 with additional information. For example, the hybrid bridge may provide the configuration server 111 with one or more of a MAC address, IP address, DNS identifier and other information or data necessary for identifying the hybrid bridge 199 and enabling the hybrid bridge 199 to act as a proxy for one or more clients 103 of the user 180 to access the browserless file storage and synchronization service.

In some implementations, the method 300 may include one or more blocks for enabling the user 180 of the client 103 to configure the client 103 allow the hybrid bridge 199 to establish one or more hooks with the client 103.

Referring now to FIGS. 4A and 4B, an example method 400 for a hybrid bridge 199 to provide a browserless file storage and synchronization for a client is depicted. In one implementation, the hybrid bridge 199 may be a processor-based computing device programmed to perform one of more steps of the method 400. Although not explicitly stated in FIGS. 4A and 4B, in some implementations all transmissions to the hybrid bridge 199 are encrypted upon receipt and decrypted by the hybrid bridge 199 following receipt. Similarly, in some implementations all transmissions from the hybrid bridge 199 are encrypted prior to transmission by the hybrid bridge 199.

At block 402 a private password is received. At block 404 the presence of an authorized user is determined based on the private password and stored password data describing one or more passwords received during configuration. At block 406 the type of operating system used by the client 103 is determined. At block 407 one or more hooks with the operating system of the client 103 are established. The hybrid bridge 199 may begin monitoring and analyzing one or more function calls, messages and events for the client 103 using the one or more hooks.

At block 408 a request associated with the client 103 may be received or collected. For example, user input data 285 may be received or collected.

At block 410 a determination may be made regarding whether an application associated with the client 103 is requesting to open a user file stored on the storage server 107. The application at block 410 is not a browser or browser-based application.

At block 412 a determination is made regarding whether the client file request is authorized. For example, the client file request may be checked against one or more of the device level settings, the device level permissions, the application-specific settings and the application-specific settings to determine if the client file request is authorized. In some implementations, requests from browsers and browser-based applications are disallowed in all circumstances.

At block 414 a server file request consistent with the client file request may be determined. For example, the synchronization module 214 may determine a server file request that requests that the storage server 107 provide application data for graphically depicting the content of the user file which was requested at block 410.

Referring now to FIG. 4B, the method 400 continues at block 416 where the server file request is transmitted. The storage server 107 may receive the server file request. At block 418 application data responsive to the server file request may be received. The application data may include data necessary for enabling the application of the client 103 to graphically depict the content of the requested user file requested at block 410 even though the user file data is stored on the storage server 107 and never transmitted to the hybrid bridge 199 or the client 103. The storage module 182 of the storage server 107 may include code and routines configured to generate the application data consistent with the server file request.

At block 420 the application data may be provided to the client so that the application can display the content of the user file stored on the storage server 107. At block 422 one or more user inputs are received or collected from the client 103. The one or more user inputs may be received or collected based on the one or more hooks established with the operating system of the client 103. The one or more user inputs may be described by user input data 285. At block 424 the one or more user inputs are analyzed to determine one or more edits for the user file data stored by the storage server 107. For example, the user 180 of the client 103 may be using the application to edit the content of the user file.

At block 426 an edit request may be provided to the storage server 107 describing the edits for the user file data. In some implementations the edit request may be generated by the synchronization module 214. The storage server 207 may receive the edit request.

At block 428 edited application data may be received responsive to the edit request. The edited application data may include data necessary for enabling the application of the client 103 to graphically depict the content of the requested user file including the edits for the content of the user file consistent with the edits determined at block 424. The application may use the edited application data to display the content of the user file including implementation of the edits even though the edited user file data is stored on the storage server 107 and never transmitted to the hybrid bridge 199 or the client 103. The storage module 182 of the storage server 107 may include code and routines configured to generate the edited application data consistent with the edit request. At block 430 the edited application data may be provided to the client 103 to cause the application of the client 103 to display the edited content for the file stored on the storage server 107.

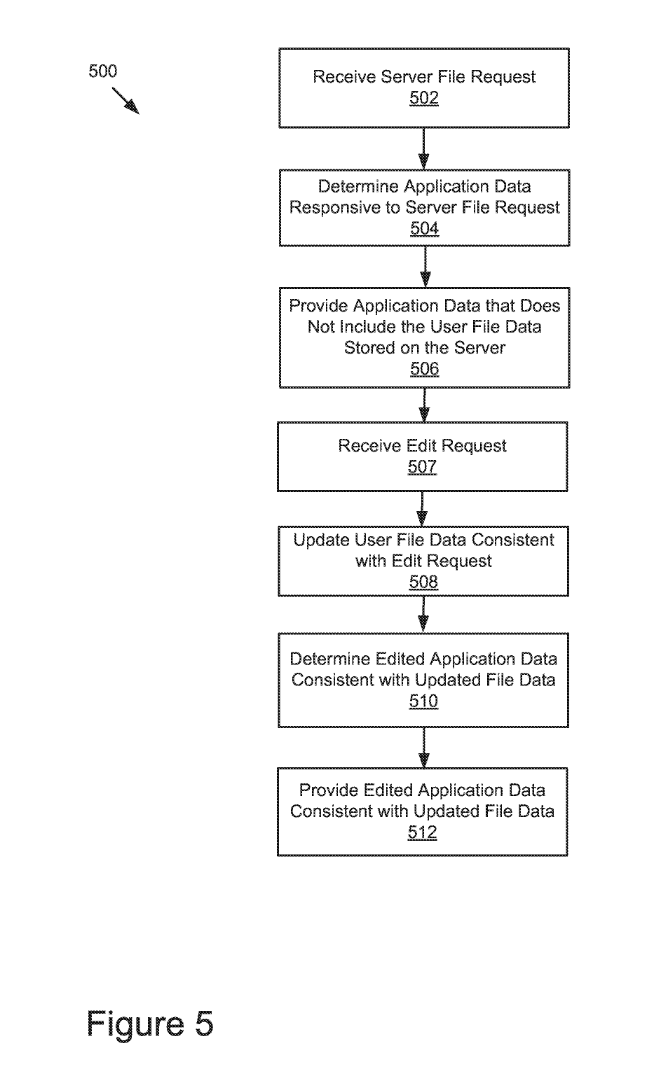

Referring now to FIG. 5, an example method 500 for server interaction with a hybrid bridge 199 is described. In one implementation, one or more of the storage server 107, the authentication server 109 and the configuration server 111 may be processor-based computing devices programmed to perform one of more steps of the method 500. In some implementations, the functionality of the servers 107, 109, 111 may be incorporated into one or more servers. For the purpose of clarity, the servers 107, 109, 111 will be referred to collectively and individually as “server” with reference to FIG. 5 and method 500. In other words, it is to be understood that the word “server” when used with reference to FIG. 5 and method 500 refers to one or more of the storage server 107, the authentication server 109 and the configuration server 111. FIG. 5 and method 500 may describe FIG. 4 and method 400 from the perspective of the server. Although not explicitly stated in FIG. 5, in some implementations all transmissions to the server are encrypted upon receipt and decrypted by the server following receipt. Similarly, in some implementations all transmissions from the server are encrypted prior to transmission by the server.

At block 502 the server file request is received. The server file request may be provided by the hybrid bridge 199. At block 504 application data consistent with the server file request is determined. At block 506 the application data may be provided to the hybrid bridge 199. The application data does not include the user file data stored by the server. At block 507 an edit request is received. At block 508 the user file data is updated consistent with the edit request, resulting in updated file data stored by the server. At block 510 edited application data consistent with the updated file data is determined. At block 512 the edited application data is provided to the hybrid bridge 199.

### Example Graphical User Interfaces (GUIs)

FIGS. 6A, 6B, 6C and 6D include graphical illustrations of example GUIs for a client 103 to display content associated with a hybrid bridge 199. The combination of FIGS. 6A, 6B, 6C and 6D may depict a file stored by the storage server 107 being opened by an application of the client 103 and edited by the user 180 of the client 103 and the application. The file data for the file are never transmitted to the hybrid bridge 199 or the client 103.

Referring to FIG. 6A, element 699 includes a graphical illustration of a desktop for a client 103 including a GUI 605 depicting a first folder and a second folder that are stored by the storage server 107. The user 180 of the client 103 may select to open one or more of the first folder and the second folder.

Referring to FIG. 6B, element 697 includes a graphical illustration of a desktop for a client 103 including a GUI 610 depicting a first file and a second file that are stored by the storage server 107. The user 180 of the client 103 may select to open one or more of the first file and the second file. The first file is a .doc file. The second file is a .pdf file. Other file types are possible.

Referring to FIG. 6C, element 695 includes a graphical illustration of a desktop for a client 103 including a GUI 615 depicting the content of the first file which is stored by the storage server 107. The user 180 of the client 103 may provide inputs to edit the file or take other actions relative to the file.

Referring to FIG. 6D, element 693 includes a graphical illustration of a desktop for a client 103 including a GUI 620 depicting edited content for the first file. The file data for the first file is stored by the storage server 107. When compared to the element 615 of FIG. 6C, the content of the first file includes new characters. The new characters are included in element 625. Element 625 includes a black box to indicate the new characters which have been added to the content for the file. The new characters are the result of the user 180 providing user inputs to edit the content of the file even though the file data for the file is stored by the storage server 107 and has never been transmitted to the hybrid bridge 199 or the client 103.

In the above description, for purposes of explanation, numerous specific details are set forth in order to provide a thorough understanding of the specification. It will be apparent, however, to one skilled in the art that the disclosure may be practiced without these specific details. In some instances, structures and devices are shown in block diagram form in order to avoid obscuring the description. For example, the implementations may be described above primarily with reference to user interfaces and particular hardware. However, the implementations may apply to any type of computing device that may receive data and commands, and any peripheral devices providing services.

Reference in the specification to “some implementations” or “some instances” means that a particular feature, structure, or characteristic described in connection with the implementations or instances may be included in at least one implementation of the description. The appearances of the phrase “in some implementations” in various places in the specification are not necessarily all referring to the same implementations.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms including “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

The implementations of the specification may also relate to an apparatus for performing the operations herein. This apparatus may be specially constructed for the required purposes, or it may include a general-purpose computer selectively activated or reconfigured by a computer program stored in the computer. Such a computer program may be stored in a computer-readable storage medium, including, but is not limited to, any type of disk including floppy disks, optical disks, CD-ROMs, magnetic disks, read-only memories (ROMs), random access memories (RAMs), EPROMs, EEPROMs, magnetic or optical cards, flash memories including USB keys with non-volatile memory, or any type of media suitable for storing electronic instructions, each coupled to a computer system bus.

The specification may take the form of some entirely hardware implementations, some entirely software implementations, or some implementations containing both hardware and software elements. In some preferred implementations, the specification is implemented in software, which includes, but is not limited to, firmware, resident software, microcode, etc.

Furthermore, the description may take the form of a computer program product accessible from a computer-usable or computer-readable medium providing program code for use by or in connection with a computer or any instruction execution system. For the purposes of this description, a computer-usable or computer-readable medium may be any apparatus that may contain, store, communicate, propagate, or transport the program for use by or in connection with the instruction execution system, apparatus, or device.

A data processing system suitable for storing or executing program code will include at least one processor coupled directly or indirectly to memory elements through a system bus. The memory elements may include local memory employed during actual execution of the program code, bulk storage, and cache memories which provide temporary storage of at least some program code in order to reduce the number of times code must be retrieved from bulk storage during execution.

Input/output or I/O devices (including, but not limited to, keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem, and Ethernet cards are just a few of the currently available types of network adapters.

Finally, the algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the specification is not described with reference to any particular programming language. It will be appreciated that a variety of programming languages may be used to implement the teachings of the specification as described herein.

The foregoing description of the implementations of the specification has been presented for the purposes of illustration and description. It is not intended to be exhaustive or to limit the specification to the precise form disclosed. Many modifications and variations are possible in light of the above teaching. It is intended that the scope of the disclosure be limited not by this detailed description, but rather by the claims of this application. As will be understood by those familiar with the art, the specification may be embodied in other specific forms without departing from the spirit or essential characteristics thereof. Likewise, the particular naming and division of the modules, routines, features, attributes, methodologies, and other aspects are not mandatory or significant, and the mechanisms that implement the specification or its features may have different names, divisions, or formats. Furthermore, as will be apparent to one of ordinary skill in the relevant art, the modules, routines, features, attributes, methodologies, and other aspects of the disclosure may be implemented as software, hardware, firmware, or any combination of the three. Also, wherever a component, an example of which is a module, of the specification is implemented as software, the component may be implemented as a stand-alone program, as part of a larger program, as a plurality of separate programs, as a statically or dynamically linked library, as a kernel-loadable module, as a device driver, or in every and any other way known now or in the future to those of ordinary skill in the art of computer programming. Additionally, the disclosure is in no way limited to implementation in any specific programming language, or for any specific operating system or environment. Accordingly, the disclosure is intended to be illustrative, but not limiting, of the scope of the specification, which is set forth in the following claims.

What is claimed is:

1. A method for providing a browserless file storage and synchronization service for a client using a browserless device communicatively coupled to the client, the method comprising:
determining, by a processor-based computing device programmed to do the determining, a type for an operating system of the client;
establishing one or more hooks with the operating system that are consistent with the type for the operating system;
monitoring activity of the client using the one or more hooks;
determining that an application included in the client is requesting to open a file stored on a server; and
providing application data to the client that is configured for the application to display content of the file which is stored on the server.

2. The method of claim 1, wherein the application is a browserless application.

3. The method of claim 1, wherein the application does not include an application program interface for accessing the browserless file storage and synchronization service.

4. The method of claim 1, wherein the application data is provided to the application using an encrypted communication and the application data is configured to enable the application to display content of the file so that a user of the client may view and edit the content of the file.

5. The method of claim 4, wherein the file is described by file data which is stored on the server and not stored on the client and the application data is configured to enable the application to receive a user input to edit the content of the file while the file data is stored on the server.

6. The method of claim 5, wherein the file data is only stored on the server and not included in the application data.

7. The method of claim 5, wherein the file data is encrypted using a password associated with a user of the client.

8. The method of claim 1, further comprising:
receiving one or more inputs;
analyzing the inputs based on the type of the operating system to determine edits for the file data; and
provide edited application data to the application to cause the application to display edited content for the file which is stored on the server.

9. The method of claim 8, wherein the edited application data is received from the server responsive to providing an edit request to the server.

10. The method of claim 9, wherein the edit request includes edit data describing the edits for the file data stored on the server and not on the client.

11. A browserless device comprising a non-transitory computer-readable medium having computer instructions stored thereon that are executable by a processing device to perform or control performance of operations comprising:
determining a type for an operating system of a client communicatively coupled to the browserless device;
establishing one or more hooks with the operating system that are consistent with the type for the operating system;
monitoring activity of the client using the one or more hooks;
determining that an application included in the client is requesting to open a file stored on a server; and
providing application data to the client that is configured for the application to display content of the file which is stored on the server.

12. The browserless device of claim 11, wherein the application is a browserless application.

13. The browserless device of claim 11, wherein the application is not a special-purpose desktop application for accessing a file storage and synchronization service.

14. The browserless device of claim 11, wherein the application data is provided to the application using an encrypted communication and the application data is configured to enable the application to display content of the file so that a user of the client may view and edit the content of the file.

15. The browserless device of claim 14, wherein the file is described by file data which is stored on the server and not stored on the client or the browserless device, and wherein the application data is configured to enable the application to receive a user input to edit the content of the file while the file data is stored on the server.

16. The browserless device of claim 15, wherein the file data is only stored on the server and not included in the application data.

17. The browserless device of claim 15, wherein the file data is encrypted using a password associated with a user of the client.

18. The browserless device of claim 11, wherein the operations further comprise:
receiving one or more inputs;
analyzing the inputs based on the type of the operating system to determine edits for the file data; and
provide edited application data to the application to cause the application to display edited content for the file which is stored on the server.

19. The browserless device of claim 18, wherein the edited application data is received from the server responsive to providing an edit request to the server.

20. The browserless device of claim 19, wherein the edit request includes edit data describing the edits for the file data stored on the server and not on the client or the browserless device.
